(19) United States
(12) Patent Application Publication
(10) Pub. No.: US 2015/0068485 A1
(43) Pub. Date: Mar. 12, 2015

(54) CYLINDER HEAD HAVING WEAR RESISTANT LASER PEENED PORTIONS

(71) Applicant: Caterpillar Inc., Peoria, IL (US)

(72) Inventors: Curtis J. Graham, Peoria, IL (US); Trent A. Simpson, Peoria, IL (US)

(73) Assignee: Caterpillar Inc., Peoria, IL (US)

(21) Appl. No.: 14/543,915

(22) Filed: Nov. 18, 2014

(51) Int. Cl. F02F 1/24

(52) U.S. Cl. CPC F02F 1/242
USPC 123/193.5

(57) ABSTRACT

A cylinder head for an internal combustion engine system is disclosed. The cylinder head has at least one fuel injector. Further, the cylinder head has at least one valve reciprocally moveable with at least one valve guide disposed within the cylinder head. The cylinder head includes a portion. The portion defines an injector mount surface. The cylinder head also includes at least one injector bore disposed within the cylinder head. The injector bore is structured and arranged to receive the injector therein. The cylinder head also includes a peening area being defined on the injector mount surface of the cylinder head. The peening area defines a region being laser peened, such that a compressive stress is induced in the peening area. The compressive stress is induced to an effective depth of approximately up to 2 mm from the injector mount surface.

### TECHNICAL FIELD

The present disclosure relates to a cylinder head for an internal combustion engine, and more particularly to portions of the cylinder head which undergo laser peening.

### BACKGROUND

Some portions of a cylinder head, such as, for example, valve guides and injector bores of an Internal Combustion (IC) engine are subjected to high tensile stresses during combustion events occurring within cylinders of the IC engine. In order to resist these tensile stresses, the valve guides and injector bores are subjected to surface engineering processes, such as, shot peening, in order to induce compressive stresses in these areas. However, a magnitude of the compressive stresses so induced may not be high enough to resist failures during engine operation. Further, an effective depth to which the compressive stresses are induced within the cylinder head is also limited. Hence, the valve guides and injector bores may not be able to sustain high tensile stresses during the combustion events, and are therefore prone to damage or failure. High costs may be associated with repair or replacement, thereby affecting service life and overall efficiency of the system.

U.S. Pat. No. 4,617,070 describes a method of using a laser on a cylinder wall to improve a cylinder liner surface. In order to prevent the formation of fissures or tears in the walls of cylinders of an internal combustion engine (ICE), hardening tracks generated by a carbon dioxide laser, are placed parallel to each other at an angle of inclination with respect to the axis of the wall of the cylinder or cylinder liner, and spaced from each other by a distance which is greater than twice the distance between the maxima of tension resulting in the operation of the ICE from the edges of the hardening track.

### SUMMARY OF THE DISCLOSURE

In one aspect of the present disclosure, a cylinder head for an internal combustion engine system is disclosed. The cylinder head has at least one fuel injector to deliver fuel from the cylinder head. Further, the cylinder head has at least one valve reciprocally moveable with at least one valve guide disposed within the cylinder head. The cylinder head includes a portion. The portion of the cylinder head defines an injector mount surface. The cylinder head also includes at least one injector bore disposed within the cylinder head. The injector bore is structured and arranged to receive the injector therein. The cylinder head also includes a peening area being defined on the injector mount surface of the cylinder head. The peening area defines a region being laser peened, such that a compressive stress of around 300 MPa to 600 MPa is induced in the peening area. The compressive stress is induced to an effective depth of approximately up to 2 mm from the injector mount surface.

Other features and aspects of this disclosure will be apparent from the following description and the accompanying drawings.

### BRIEF DESCRIPTION OF THE DRAWINGS

FIG. 1 is a perspective view of an exemplary cylinder head of an internal combustion engine including injectors and valves associated therewith, according to one embodiment of the present disclosure;

FIG. 2 is an enlarged view of the encircled area of FIG. 1;

FIG. 3 is a perspective view of the cylinder head of FIG. 1 with the valve spring assemblies and injectors removed to illustrate the injector mount surfaces;

FIG. 4 is an enlarged view of the encircled area of FIG. 3; and

FIG. 5 is a sectional view of a portion of the cylinder head of FIG. 1, cross-sectioned along line 5-5 of FIG. 1 illustrating an injector bore of the cylinder head.

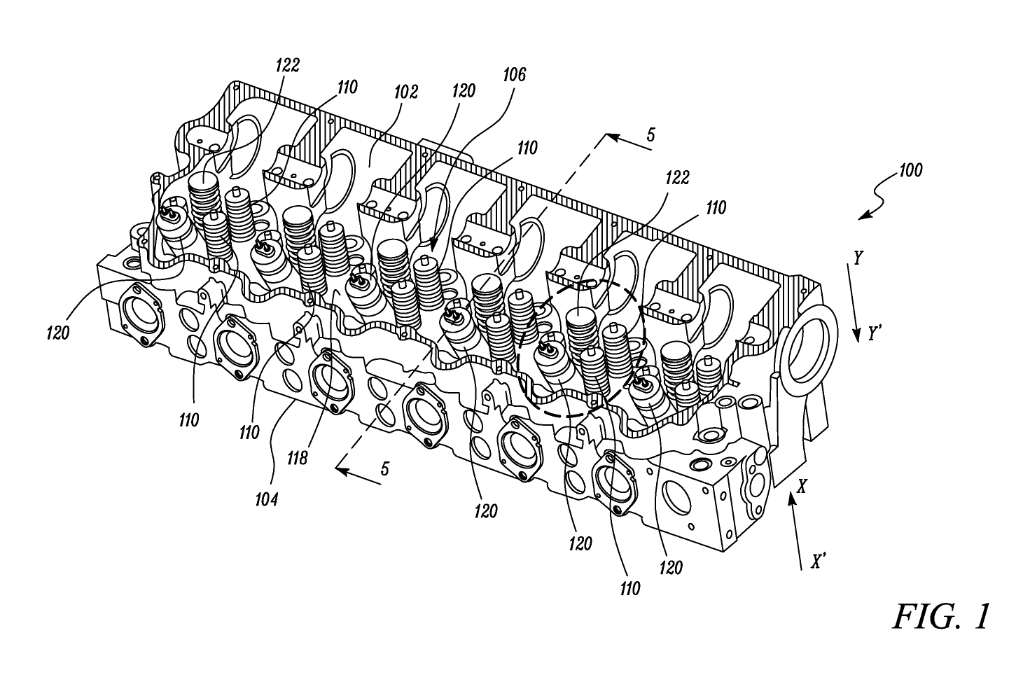

### DETAILED DESCRIPTION

Wherever possible, the same reference numbers will be used throughout the drawings to refer to the same or the like parts. Referring to FIG. 1, a perspective view of an exemplary cylinder head 100 associated with an engine is illustrated. In one embodiment, the engine may include a compression ignition internal combustion engine configured to combust a mixture of air and diesel fuel. In alternative embodiments, the engine may include a spark ignition engine, such as, a natural gas engine, a gasoline engine, or any multi-cylinder reciprocating internal combustion engine known in the art. The primary components of the engine include an engine block (not shown) and the cylinder head 100. In one example, the engine block and the cylinder head 100 may be made from cast iron. On assembling the cylinder head 100 with the engine block, the cylinder head 100 is aligned and bolted to the engine block as is customary. A gasket (not shown) may be provided between the engine block and the cylinder head 100, as is customary, to form a seal between the engine block and the cylinder head 100 in preparation for high temperatures and high pressures associated with combustion gases formed in each cylinder during operation of the engine.

The engine block includes a plurality of cylinders (not shown) and each cylinder includes a piston (not shown) and a liner (not shown) disposed within the cylinder. An engine may have multiple cylinders for exemplary purposes the present disclosure illustrates an engine block and the cylinder head 100 associated with a six cylinder engine commonly referred to as an inline configuration. Alternatively, the present disclosure cylinder head 100 may include fewer or more valve and injector sets associated with less than 6 cylinders or more than 6 cylinders, such as, for example an 8 cylinder V-configuration engine. The engine may be configured for any suitable application, such as, work machines, locomotives or marine engines, and in stationary applications, such as, electrical power generators.

Each of the cylinders (not shown) includes the piston (not shown) and a connecting rod assembly (not shown). During a combustion event of the mixture of air and the fuel, high pressure is generated within the cylinders which cause an increase in the temperature of the mixture resulting in combustion. In turn, combustion acts on the piston head (not shown) and forces the piston to translate within the cylinder. As is customary the connecting rod is configured to convert the translatory motion of the piston to a rotary motion of the crankshaft.

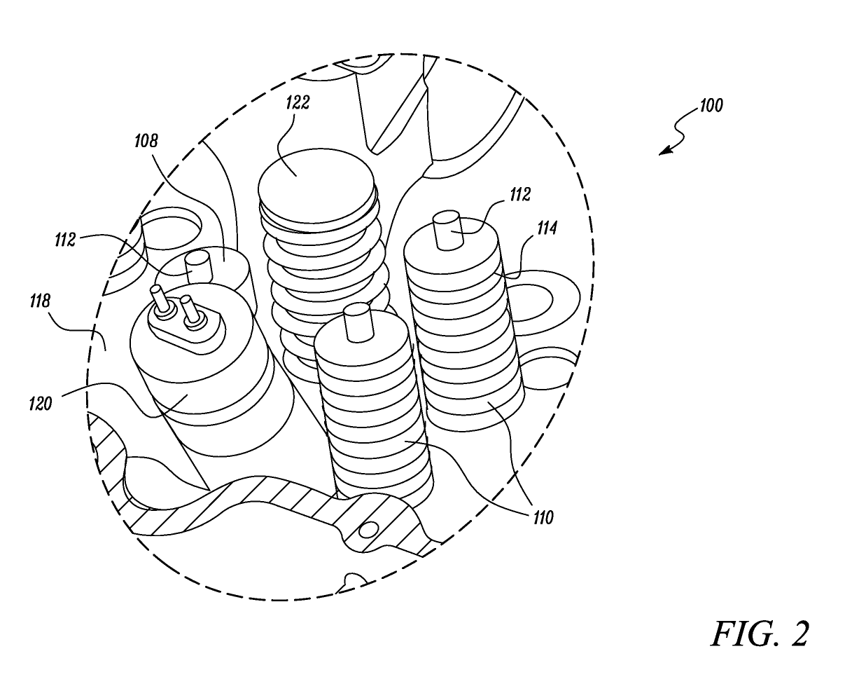

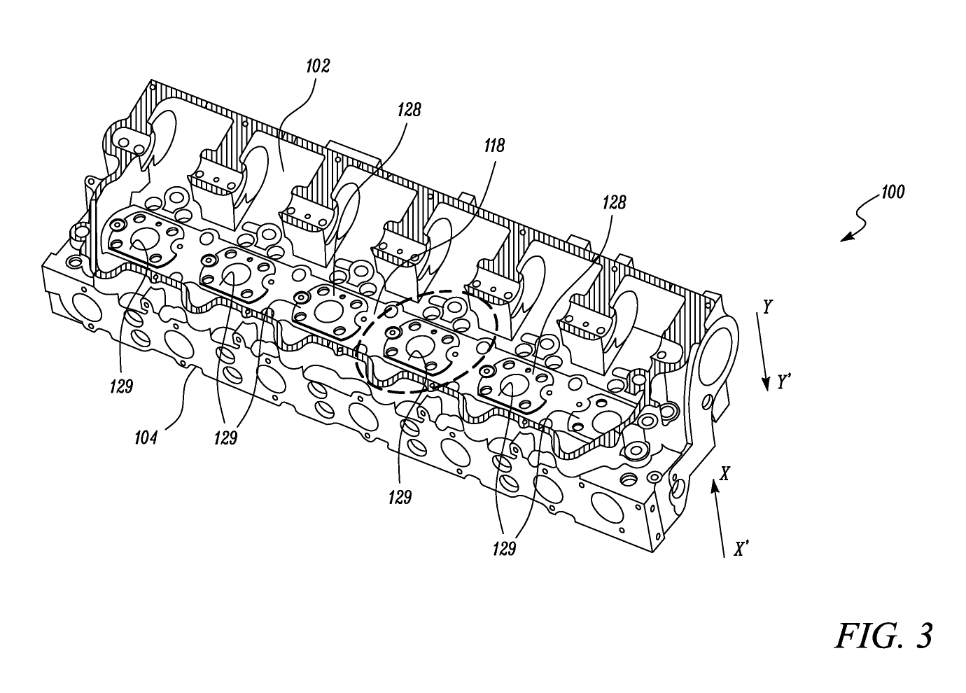

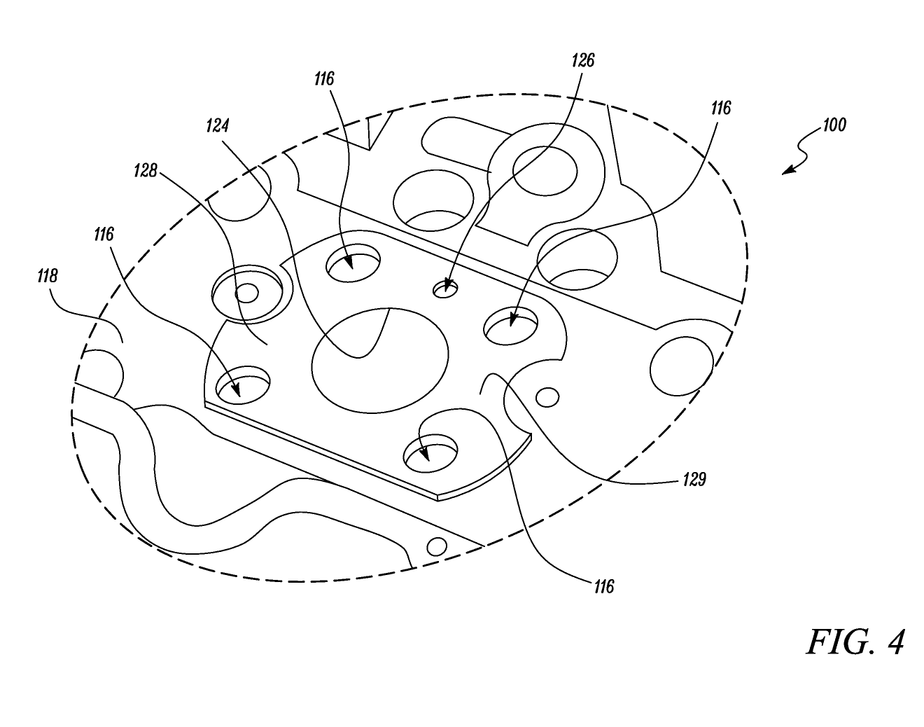

Referring now to FIGS. 1, 2, and 5, the cylinder head 100 includes an upper deck 102 and a lower deck 104. Further, a valve train 106 is associated with the engine. Some parts of the valve train 106 are shown in the accompanying figures. The valve train 106 is provided within the cylinder head 100 of the engine. The valve train 106 may include one or more intake valves 108 and exhaust valves 110. The intake and exhaust valves 108, 110 may be configured to open and close an intake port (not shown) and an exhaust port (not shown) of the cylinders respectively, in order to control air, fuel mixture (intake) and exhaust gas flow (exhaust) within the cylinders, thereby facilitating combustion. In an exemplary embodiment, each cylinder is provided with two intake valves 108 and two exhaust valves 110. The valves 108, 110 disclosed herein may embody a known valve such as, for example, a poppet valve. Each valve 108, 110 may include a valve stem 112 (see FIGS. 1, 2 and 5) and a valve spring 114 (see FIGS. 1, 2 and 5). The valve stem 112 of the valves 108, 110 is received within a respective valve guide 116 (see FIGS. 3 and 4) provided in the cylinder head 100, and reciprocate therein during an opening or closing of the valves 108, 110. The valve guides 116 are provided within a portion 118 of the upper deck 102 of the cylinder head 100. The valves 108, 110 are retained in the closed position by means of the valve spring 114.

The valve train 106 also includes a camshaft (not shown), a tappet (not shown), a push-rod (not shown) and a rocker arm (not shown). The camshaft may be disposed within the cylinder head 100 of the engine. Alternatively, the camshaft may be disposed within the engine block of the engine. The camshaft may be configured to operate the tappet of the valve train 106, followed by the push rod, the rocker arm, the valve stem 112, and thereafter the valves 108, 110.

In order to supply the fuel that the engine combusts during the combustion event, a fuel system (not shown) is operatively associated with the engine. A fuel line (not shown) may be provided as a component of the fuel system to carry the fuel from a tank (not shown) to the engine. A fuel pump (not shown) may be provided in the fuel line to pressurize and force the fuel through the fuel line.

Further, in order to introduce the fuel into the cylinders, the fuel system (not shown) may include multiple fuel injectors 122 each being operably connected to an actuator 120 (see FIGS. 1, 2 and 5). In an exemplary embodiment, one fuel injector 122 and one actuator 120 is associated with each cylinder. Alternatively, a fewer number of fuel injectors may be employed in any manner known to those with ordinary skill in the art. The fuel injectors 122 are controlled by the electrically operated actuators 120 for selectively introducing a predetermined quantity of the fuel into the cylinder. The fuel injectors 122 are mounted to injector mount surfaces 129 within the cylinder head 100. More particularly, the fuel injectors 122 are mounted such that a portion of each fuel injector 122 extends within an injector bore 124 (see FIGS. 3, 4, and 5) of the cylinder head 100. The injector bores 124 extend through the portion 118 of the cylinder head 100. Further, a threaded bore 126 extends through each injector mount surface 129 to receive a fastener (not shown) therein to thereby mount the fuel injector 122 to the injector mount surface 129 of the cylinder head 100.

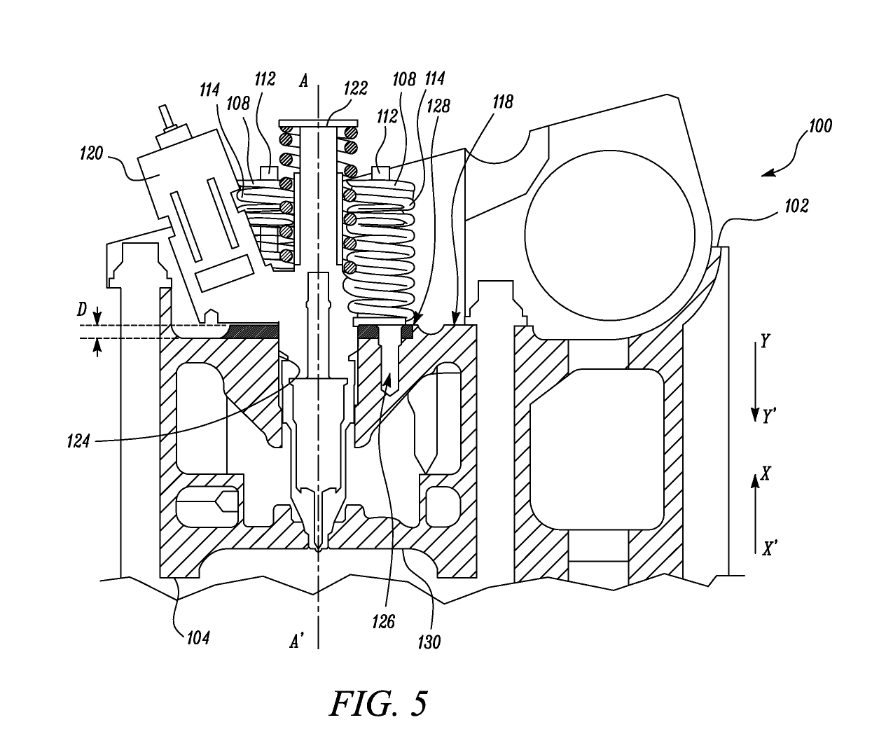

As best shown in FIG. 5, due to the combustion events occurring within the cylinders of the engine, a significant amount of pressure is imparted on a combustion face 130 of the lower deck 104 within each cylinder interface with the cylinder head 100. This pressure creates tensile stresses in the cylinder head 100 and such tensile stresses tend to propagate through the cylinder head 100, along a direction X-X′, such that the upper deck 102, and more particularly, the portion 118 of the cylinder head 100 provided with the valve guides 116 and the injector bores 124 is subjected to these high tensile stresses. A surface engineering process may be applied to the injector mount surface 129 of the portion 118 of the cylinder head 100. In an exemplary embodiment of the present disclosure, the surface engineering process may include laser peening. Laser peening is configured to induce compressive stresses within the area of which it is applied to the cylinder head 100 in order to resist the high tensile stresses created during the combustion events. Laser peening an area of the injector mount surface 129, termed the peening area 128, acts to introduce compressive stresses to the cylinder head 100 along a direction Y-Y′. A value of the compressive stresses being induced within the portion 118 may be, for example, between 300 to 600 MPa such as 350 to 450 MPa, for example. Alternatively, the compressive stress induced in the cylinder head 100 may be between 400 to 600 MPa, for example.

Laser peening may be carried out using known laser peening equipment. Laser peening equipment may include, for example, but not limited to, a laser beam, a target provided over the portion 118, and a confining media. In one example, the laser beam may include a Neodymium glass (Nd) laser. Further, the high energy pulsed laser beam in association with the target and the confining media may produce an intense shock wave on the portion 118 to induce a strong localized compressive stress within the portion 118. Different combinations of the parameters, namely, the laser beam, the target, and the confining media may be used based on system requirements.

As shown in FIGS. 3 and 4, the peening area 128 is defined on the portion 118 of the cylinder head 100. The peening area 128 defines a region of the cylinder head 100 formed using laser peening, such that the compressive stresses are induced within the peening area 128 to an effective depth “D”, along the direction Y-Y′. More particularly, the peening area 128 surrounds the injector bore 124, the threaded bore 126, and the valve guides 116. The injector bore 124, the threaded bore 126, and the valve guides 116 are provided in close proximity to one another, and so the peening area 128 is defined such that the peening area 128 surrounds the injector bore 124, the threaded bore 126, and the valve guides 116. However, a person of ordinary skill in the art would appreciate that the shape and size of the peening area 128 may vary based on the location of the injector bore 124, the threaded bore 126, and the valve guides 116 respectively on the portion 118 of the cylinder head 100, such that the peening area 128 surrounds the injector bore 124, the threaded bore 126, and the valve guides 116 within a defined diameter based on a size of the engine.

Referring to FIG. 5, treating the laser peening area 128 to the effective depth “D” will induce compressive stresses within this peening area 128. For example, the effective depth, “D” may be approximately 2 mm deep measured in the Y-Y′ direction from the portion 118. It should be noted that the effective depth “D” is not limited hereto, and may change based on parameters, such as, the material of the cylinder head 100 and the laser peening equipment being used.

### INDUSTRIAL APPLICABILITY

The cylinder head of internal combustion engine are subjected to high tensile stresses on account of the combustion events occurring within the cylinders. In order to resist these tensile stresses, certain surfaces are subjected to laser peening which has the effect of creating deeper compressive stress penetration of the material. The present disclosure describes the laser peening of the peening area 128 in order to induce compressive stresses within the peening area 128 of the portion 118 to the depth, “D” which may be approximately 2 mm. By using laser peening, it is possible to achieve compressive stress levels of up to 2 to 3 times higher than that of shot peening process. In some examples, the compressive stress values induced in the cylinder head 100 may be between 300 to 600 MPa. Also, the compressive stresses may be pushed deeper into the portion 118, creating a thicker layer of pre-stressed material within the portion 118, thereby increasing fatigue strength of the portion 118.

Further, the injector bore 124, the threaded bore 126, and the valve guides 116 may be less susceptible to stress fractures or cracking caused by the induced tensile stresses. Hence, the cylinder head 100 may not require frequent remanufacturing, thereby reducing a cost associated with the remanufacturing of the cylinder head 100. The use of laser peening may also provide an improved surface finish on the portion 118 of the cylinder head 100. Further, no residual shot material may need be cleaned from the peening area 128, thereby decreasing time associated with manufacturing of the cylinder head 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cylinder head for an internal combustion engine system using at least one fuel injector to deliver fuel from the cylinder head, and the cylinder head having at least one valve reciprocally moveable with at least one valve guide disposed within the cylinder head, the cylinder head comprising:
a portion of the cylinder head defining an injector mount surface and at least one injector bore disposed within the cylinder head, the injector bore being structured and arranged to receive the injector therein; and
a peening area being defined on the injector mount surface of the cylinder head, the peening area defining a region being laser peened such that a compressive stress of around 300 MPa to 600 MPa is induced in the peening area, to an effective depth of approximately up to 2 mm from the injector mount surface.
